(19) United States
(12) Patent Application Publication
(10) Pub. No.: US 2013/0036999 A1
(43) Pub. Date: Feb. 14, 2013

(54) High-Squish Combustion Chamber With Side Injection

(71) Applicants: Robert Levy, Dryden, MI (US); Diana Brehob, Dearborn, MI (US)

(72) Inventors: Robert Levy, Dryden, MI (US); Diana Brehob, Dearborn, MI (US)

(73) Assignee: ECOMOTORS INTERNATIONAL, INC., Allen Park, MI (US)

(21) Appl. No.: 13/563,797

(22) Filed: Aug. 1, 2012

Related U.S. Application Data
(60) Provisional application No. 61/515,996, filed on Aug. 8, 2011.

(51) Int. Cl. F02B 3/02; F02B 75/28

(52) U.S. Cl. 123/299; 123/294

(57) ABSTRACT

A combustion chamber for an internal combustion engine is disclosed in which the piston has a large squish region at a peripheral location on the piston top and a depression in the center of the piston top. A side injector sprays fuel into the depression in the piston top through a channel defined in the squish region. In some embodiments, two injectors are provided that are diametrically opposed to each other. In some embodiments, the engine is an opposed-piston engine in which each piston has the squish regions and depressions in the piston top.

### CROSS REFERENCE TO RELATED APPLICATIONS

The present application claims priority benefit from U.S. provisional patent application 61/515,996 filed 8 Aug. 2011.

### FIELD

The present disclosure relates to shape of the combustion chamber and injector orientation in internal combustion engines.

### BACKGROUND

Thermal efficiency and engine-out emissions from an internal combustion engine are determined by many factors including the combustion chamber shape, the fuel injection nozzle, and fuel injection pressure, to name a few. Much is known and has been studied in typical diesel engine combustion chambers. However, in unconventional engines, less is known about what combustion chamber shape and fuel injection characteristics can provide the desired performance.

Such an unconventional engine, an opposed-piston, opposed-cylinder (OPOC) engine 10, is shown isometrically in FIG. 1. An intake piston 12 and an exhaust piston 14 reciprocate within each of first and second cylinders (cylinders not shown to facilitate viewing pistons). An intake piston 12′ and an exhaust piston 14 couple to a journal (not visible) of crankshaft 20 via pushrods 16. An intake piston 12 and exhaust piston 14′ couple to two journals (not visible) of crankshaft 20 via pullrods 18, with each intake piston 12 having two pullrods 18. The engine in FIG. 1 has two combustion chambers formed between a piston top 22 of intake piston 12 (or 12′) and a piston top 24 of exhaust piston 14 (or 14′) and the cylinder wall (not shown). The pistons in both cylinders are shown at an intermediate position in FIG. 1. Combustion is initiated when the pistons are proximate each other. Piston tops 22 and 24 in FIG. 1 may not be optimized to provide the desired performance. Piston top 24 has a raised region at the periphery and a flat bowl in the middle of the chamber. The raised region, which is called squish area by those skilled in the art, is only a small portion of the total projected area of piston top 24. The total volume that can be included in the flat bowl regions of piston tops 22 and 24 is determined by the desired compression ratio. In the example in FIG. 1, the depth of the bowl is particularly limited because the cross-sectional area of the bowl in piston top 24 is large in comparison to the total projected area of piston top 24. Such a limited bowl depth allows little space to accommodate fuel jets from an injector to enter the combustion chamber without significantly impinging on piston top surfaces.

Combustion chamber configurations are disclosed in U.S. 2011/0271932 A1 in which an irregularly-shaped, non-circular bowl is formed, in some aspects as a clam shell. A lip imparts a tumble flow. It is desirable, in some situations to induce a large-scale flow structure in the combustion chamber. However, as the pistons move toward their closest position is the time when ignition of the fuel-air mixture occurs. At this instant in time, it is often desirable to have small-scale eddies which are known to be effective in enhancing quick and complete combustion. One strategy is to induce large scale mixture motion, such as swirl (having an axis of rotation parallel to the cylinder axis) or tumble (having an axis of rotation perpendicular to the cylinder axis) which can persist well before combustion, but then break down into small-scale structures just before combustion. It is desirable to determine a combustion chamber shape that causes the large-scale flow structures to devolve into smaller-scale flow structures near the time that combustion is initiated.

### SUMMARY

A combustion chamber for an internal combustion engine is disclosed in which the piston has a large squish region at a peripheral location on the piston top and a depression in the center of the piston top. A side injector sprays fuel into the depression in the piston top through a channel define in the squish region. In some embodiments, two injectors are provided that are diametrically opposed to each other. In some embodiments, the engine is an opposed-piston engine in which each piston has the squish regions and depressions in the piston top. In one embodiment, the depression is a truncated sphere.

A combustion chamber includes a cylinder wall; a first fuel injector disposed in a first opening defined in the cylinder wall; a first piston disposed within the cylinder wall. The top of the piston has a flat area covering a majority of the surface area of the top of the piston and being located substantially near the periphery of the top of the piston; a centrally-located concave depression defined in the top of the piston with a center of the depression being roughly aligned with a central axis of the cylinder wall; and a first channel defined in the piston top connecting an outer edge of the piston with the depression. The piston is configured to reciprocate between an upper and a lower position and the first channel provides a line-of-sight opening between a tip of the first injector and the depression when the piston is at its upper position. The concave depression is a truncated sphere with a diameter of the truncated sphere less than a diameter of the piston in one alternative. In another alternative, the concave depression is wedge shaped; with the depth of the depression increasing with distance away from the first injector between the channel and a central axis of the piston; i.e., at the edge of the depression distal from the first fuel injector, the depth of the depression decreases with distance away from the first injector markedly to form a wall that directs fuel injected from the first fuel injector out of the depression.

Some embodiments include a second channel defined in the piston top connecting an outer edge of the piston with the depression and a second fuel injector disposed in a second opening defined in the cylinder wall with an axis of the second fuel injector roughly normal to the cylinder wall at the point at which the second fuel injector pierces the cylinder wall. The second fuel injector is substantially diametrically opposed to the first fuel injector and the second injector is aligned with the second channel.

A first injection orifice is defined in the first injector and a second injection orifice is defined in the second injector. A spray exiting from the first injector aligns with the first channel when the piston is near its upper position and a spray exiting from the second injector aligns with the second channel when the piston is near its upper position. The spray from the first injector angles slightly upward and the spray from the second injector angles slightly downward. The sprays from the first and second injectors are angled so that the sprays remain substantially independent of each other. The combustion chamber is comprised of a volume enclosed by the tops of the first and second pistons and the cylinder wall. In some embodiments, the diameter of the depression in the piston top is roughly half of the diameter of the piston.

Also disclosed is an internal combustion engine having a cylinder wall, a first piston disposed in the cylinder liner, a second piston disposed in the cylinder liner in an opposed arrangement with respect to the first piston, a crankshaft having eccentric journals, connecting rods coupling the pistons with eccentric journals of the crankshaft wherein the pistons have an upper position in which a volume in the combustion chamber is at a minimum, and a first fuel injector disposed in a first opening defined in the cylinder wall. The pistons each have: a flat area covering a majority of the surface area of a top of the piston with the flat area substantially being located peripherally on the top of the piston. A generally-rounded, concave depression is defined in the top of the piston. The first piston has a first channel defined in the first piston top with the first channel providing a line-of-sight opening between a tip of the first injector and the depression in the first piston when the first piston is at its upper position.

Some alternatives include a second fuel injector disposed in a second opening defined in the cylinder wall. The second piston has a second channel defined in the second piston top with the second channel providing a line-of-sight opening between a tip of the second injector and the depression in the second piston when the second piston is at its upper position. The concave depression in each piston is substantially a truncated sphere with the deepest point of the depression substantially coincident with a central axis of the cylinder, in one alternative. The concave depression is wedge shaped in which a depth of the depression near the injector is less than the depth of the depression near a central axis of the cylinder, in an alternative depression. An orifice of the first fuel injector is oriented to direct a fuel jet into the depression in the first piston and an orifice of the second injector is oriented to direct a fuel jet into the depression in the second piston. Or, in multi-orifice injectors, a plurality of orifices defined in the first fuel injector are oriented to direct fuel jets into the depression in the first piston and a plurality of orifices defined in the second injector are oriented to direct fuel jets into the depression in the second piston. Orifices of the first and second fuel injectors are oriented so that a fuel jet exiting the first injector is substantially directed to one side of a plane between tips of the first and second injectors that aligns with a central axis of the cylinder and a fuel jet exiting the second injector is substantially directed to the other side of the plane.

An engine having a cylinder wall, a first piston disposed in the cylinder liner, a second piston disposed in the cylinder liner in an opposed arrangement with respect to the first piston, at least one crankshaft having eccentric journals, connecting rods coupling the pistons with eccentric journals of the at least one crankshaft wherein the pistons have an upper position in which a volume in the combustion chamber is at a minimum, and a first fuel injector disposed in the cylinder wall with an axis of the fuel injector roughly normal to the cylinder wall proximate a location where the first fuel injector pierces the cylinder wall is disclosed. Each piston has a flat area covering a majority of the surface area of a top of the piston with the flat area being located peripherally on the top of the piston. Each piston has a roughly centrally-located depression defined in the piston top. The first piston has a first channel defined in the piston top with the first channel providing a line-of-sight opening between a tip of the first injector and the depression when the first piston is at its upper position. The engine may also have a second fuel injector disposed in the cylinder wall with an axis of the second fuel injector roughly normal to the cylinder wall proximate a location where the second fuel injector pierces the cylinder wall. The second piston further includes a second channel defined in the piston top of the second piston with the second channel providing a line-of-sight opening between a tip of the second injector and the truncated sphere when the second piston is at its upper position. The depression is a truncated sphere. Alternatively, the depression is fan shaped as viewed onto the top of the piston and is wedge shaped as viewed in cross section where the depth of the depression increases as viewed from near the injector to a central axis of the cylinder.

### BRIEF DESCRIPTION OF THE DRAWINGS

FIG. 1 is an isometric drawing of an OPOC engine;

FIG. 2 is a cross-sectional view of a combustion chamber according an embodiment of the disclosure; and

FIGS. 3 and 4 are top views of the intake piston of FIG. 2;

FIG. 5 is a cross-sectional view of the exhaust piston of FIG. 2;

FIGS. 6, 9 and 10 are cross-sectional views of combustion chambers according embodiments of the disclosure;

FIG. 7 is a top view of the intake piston of FIG. 6; and

FIG. 8 is a top view of an intake piston according to an embodiment of the disclosure.

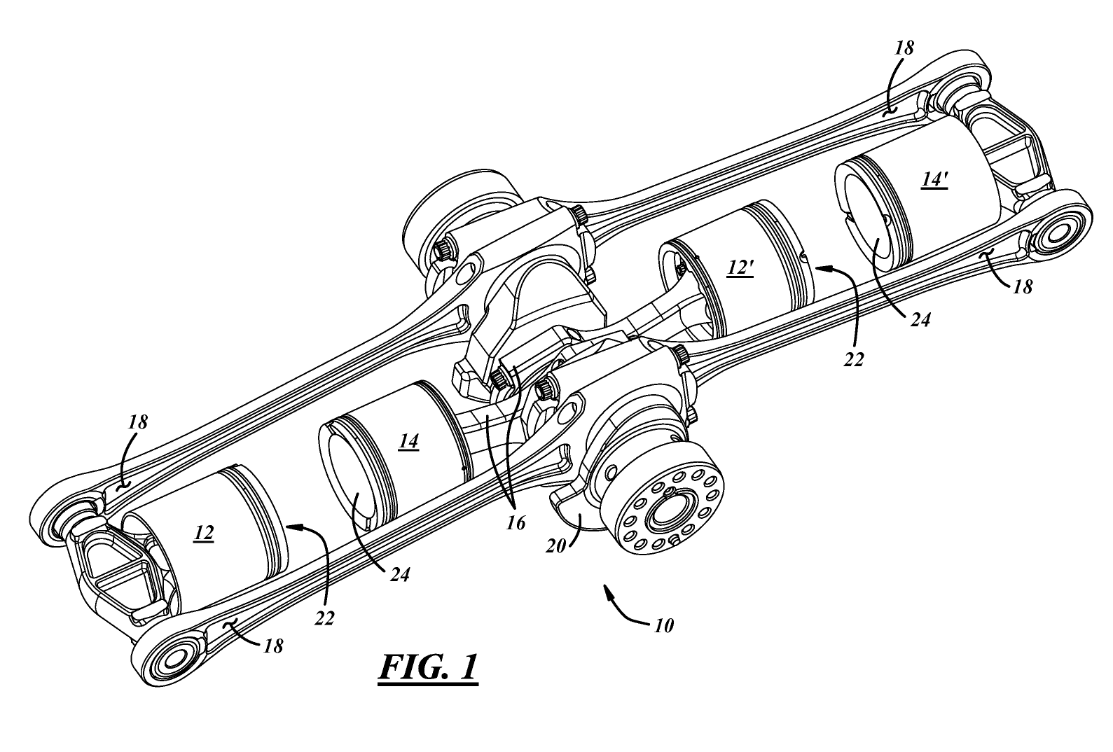

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

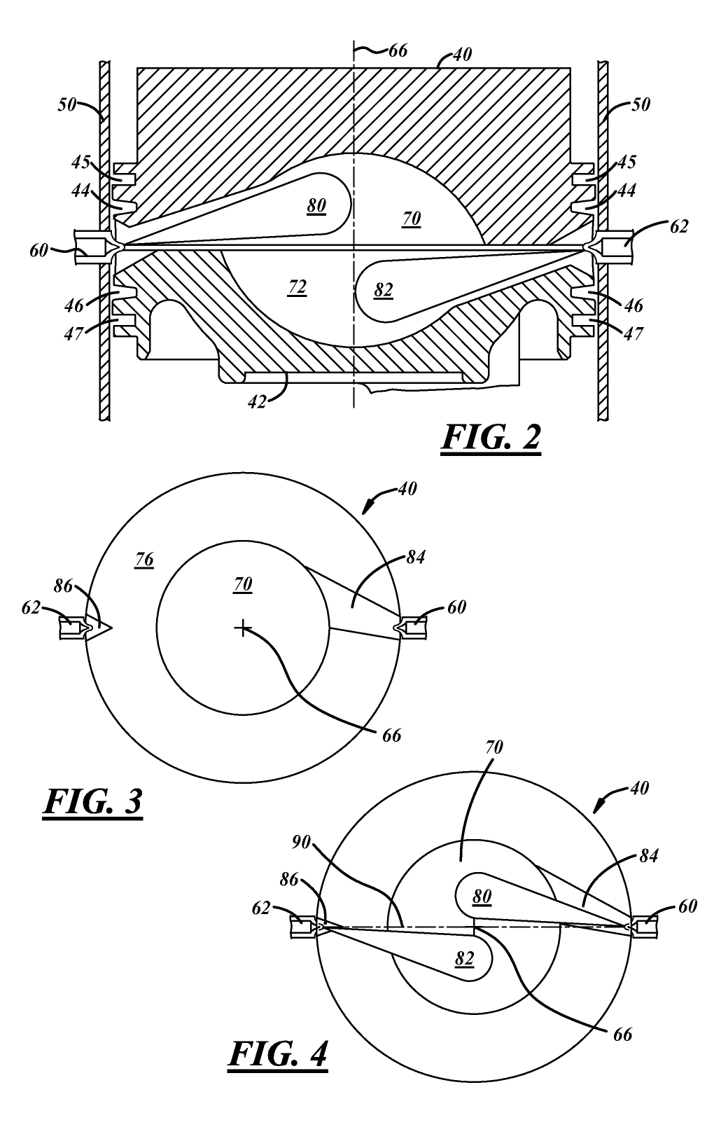

In FIG. 2, a cross section of a portion of an OPOC engine is shown illustrating a combustion chamber according to an embodiment of the disclosure. A portion of intake piston 40 and a portion of exhaust piston 42 are shown at their closest position. Piston 40 has grooves 44 and 45 and piston 42 has grooves 46 and 47 to accommodate piston rings (not shown). Pistons 40 and 42 reciprocate within cylinder wall 50. The combustion chamber is the volume enclosed between the tops of pistons 40 and 42 and the cylinder wall 50. The piston tops of both intake and exhaust pistons 40 and 42 are flat at their peripheral regions. These flat regions are separated from each other by a predetermined distance. The predetermined distance is in the range of 0.5-2.0 mm. Those skilled in the art appreciate that the predetermined distance varies depending on the particulars of the engine including size, tolerances, etc. Such range is provided as an example and not intended to be limiting. In the region of the piston top proximate a central axis of the cylinder 66, depressions 70 and 72 are provided in intake piston 40 and exhaust piston 42, respectively. In one embodiment, the depressions 70 and 72 are truncated spheres. Also shown in FIG. 2 are fuel injectors 60 and 62 that pierce cylinder wall 50. An orifice in injector 60 is arranged so that a fuel jet 80 is directed into depression 70 and an orifice in injector 62 is arranged so that a fuel jet 82 is directed into depression 72. The combustion chamber is defined by the tops of pistons 40 and 42 and cylinder wall 50. At the position of the pistons shown in FIG. 2, the volume of the combustion chamber is substantially contained in depressions 70 and 72.

In FIG. 3 a view of the top of intake piston 40 is shown. Intake piston 40 has the truncated spherical depression 70 in the center of the piston top and a flat squish region 76 at the outside of the piston top. When the two pistons approach each other, the gases between the squish regions of the two pistons are forced into depression 70 thereby promoting turbulence in the combustion chamber. A channel 84 is defined in intake piston 40 at a location proximate injector 60. Channel 84 provides a path for fuel exiting injector 60 to access the depression 70 in which much of the air for combustion is located. In the embodiment of FIG. 2, fuel jet 80 is directed upward into depression 70. A small channel 86 is defined in squish region 76 to accommodate injector 62. However, as fuel jet 82 from injector 62 is directed downward into depression 72, as shown in FIG. 2, little accommodation is provided for fuel jet 82 because fuel jet 82 is directed downward into depression 72.

In the combustion chamber illustrated in FIGS. 2-4, the cross-sectional area of the squish region is approximately two-thirds of the total cross-sectional area of the piston top. Devoting such a high fraction of the piston top to squish promotes a high degree of turbulence to gases in the cylinder which is a particular advantage of the presently-disclosed embodiment. The two-thirds fraction is provided as an example and is not intended to be limiting. According to the present disclosure, the cross-sectional area of the squish region covers a majority of the cross-sectional area of the piston top.

In FIG. 4, a plan view of the top of intake piston 40 is shown with fuel jets 80 and 82 exiting from injectors 60 and 62, respectively. Fuel jet 80 is directed downward into depression 70 and fuel jet 82 is directed upward. Fuel jets 80 and 82 are aimed off axis so that they do not overlap each other. A vertical plane between injectors 60 and 62 including central axis 90 bisects the cylinder (not shown). Fuel from jet 80 is substantially on one side of plane 90 and fuel from jet 80 is substantially on the other side of plane 90.

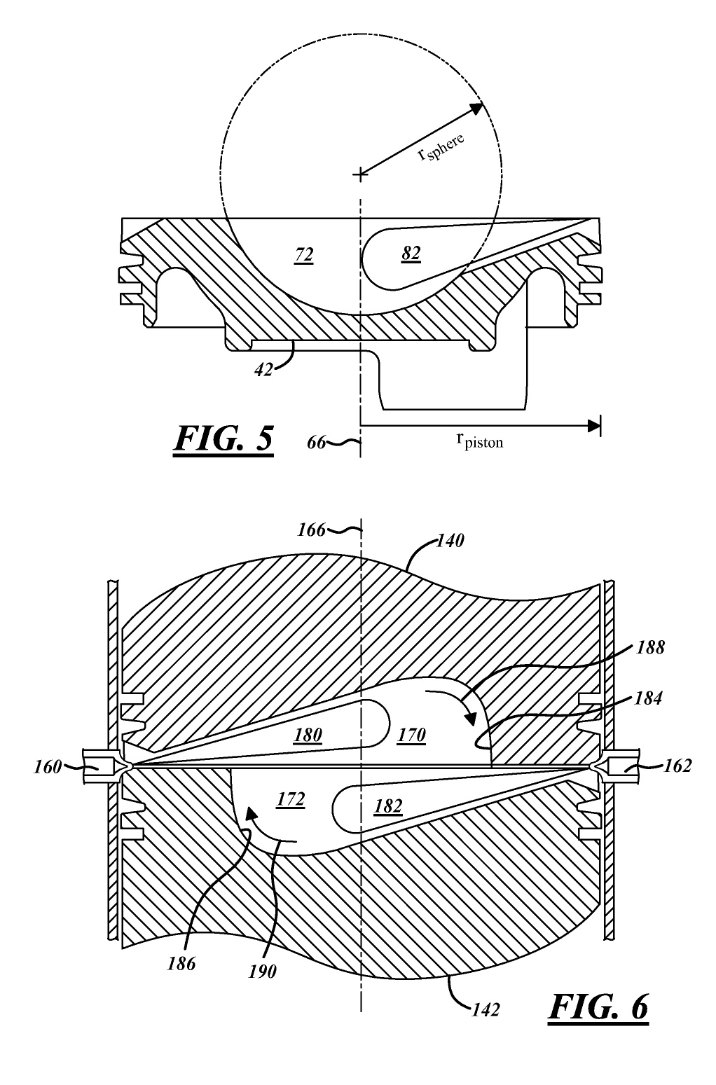

In FIG. 5, piston 42 in cross section shows that the radius of the piston is greater than the radius of the truncated sphere 72. In an alternative embodiment, the truncated sphere has a radius greater than the radius of the piston.

In FIG. 6, a combustion chamber system is shown in which depressions 170 and 172 in pistons 140 and 142, respectively, are wedge shaped such that the section nearest the associated injectors 160 and 162 (injector 160 associated with depression 170 and injector 162 associated with depression 172) is shorter and the section away from the associated injector is taller. Thus, where fuel jet 180 is more concentrated, the space is lesser. Where fuel jet 180 has spread out, the space to accommodate fuel jet 180 is greater. Walls 184 and 186 cause flow as illustrated by arrows 188 and 190 that help to prevent fuel from hitting the walls of the piston and to direct flow toward the opposite depression to aid in mixing.

In FIG. 8, an alternative piston top of piston 140, which is consistent with the cross section of FIG. 6, has the same concave depression 170. In addition to having concave depression 170, wings 190 are defined in the piston top. In an opposed-piston embodiment, piston 142 moves toward piston 140, with the fans one hundred eighty degrees rotated with respect to each other. Wings 190 are provided to accept fuel that is directed out of concave depression 172 toward piston 140.

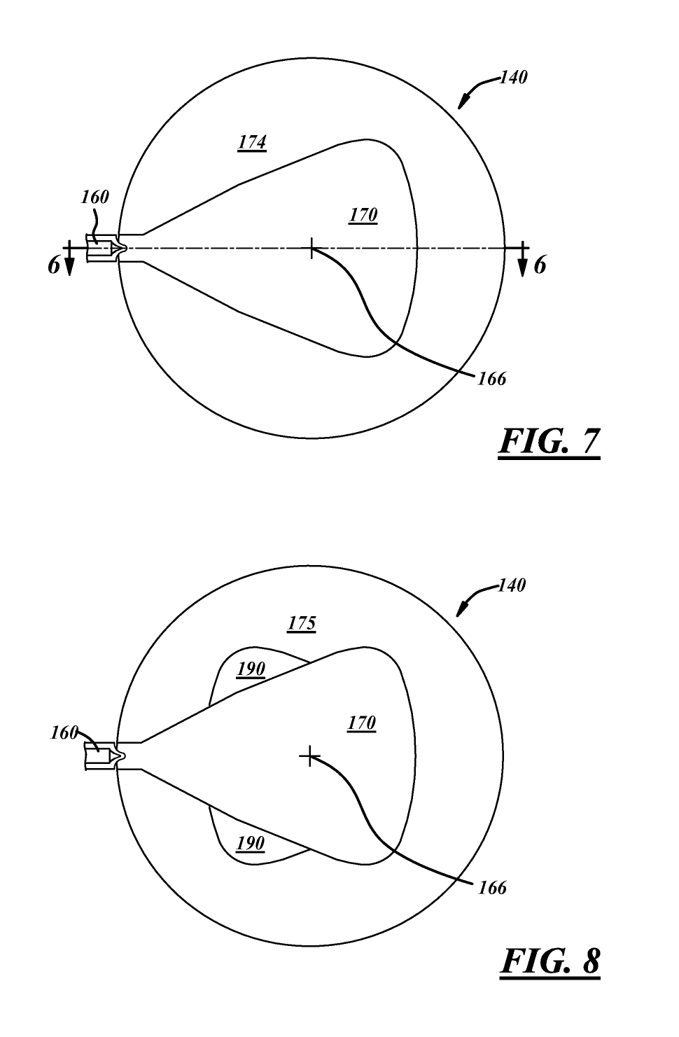

In FIG. 7, a top of piston 140 is shown. A major portion of the projected area of the piston top is flat. This flat, squish region 174 is located predominantly near the peripheral edge of piston 140. The concave depression 170 is fan shaped and opens up away from injector 160. In FIG. 6, the depth of the depression increases from injector 160 at least to central axis 166. At the far end of concave depression 170 with respect to injector 160, a wall of the depression is nearly vertical to direct the flow toward the other piston, i.e, flow in depression 172 directed toward piston 140 and flow in depression 170 directed toward piston 142.

In the embodiments described above, the peripheral part of the piston top is flat, except in the region of the passageway sculpted out to accommodate the spray. However, the piston tops in those regions may be of other shapes, but except in the place of the passageway, nearly touch when the pistons are at their closest approach during reciprocation. The distance between the piston tops of the two pistons at the closest position is at least 0.3 mm, but no larger than 1.5 mm.

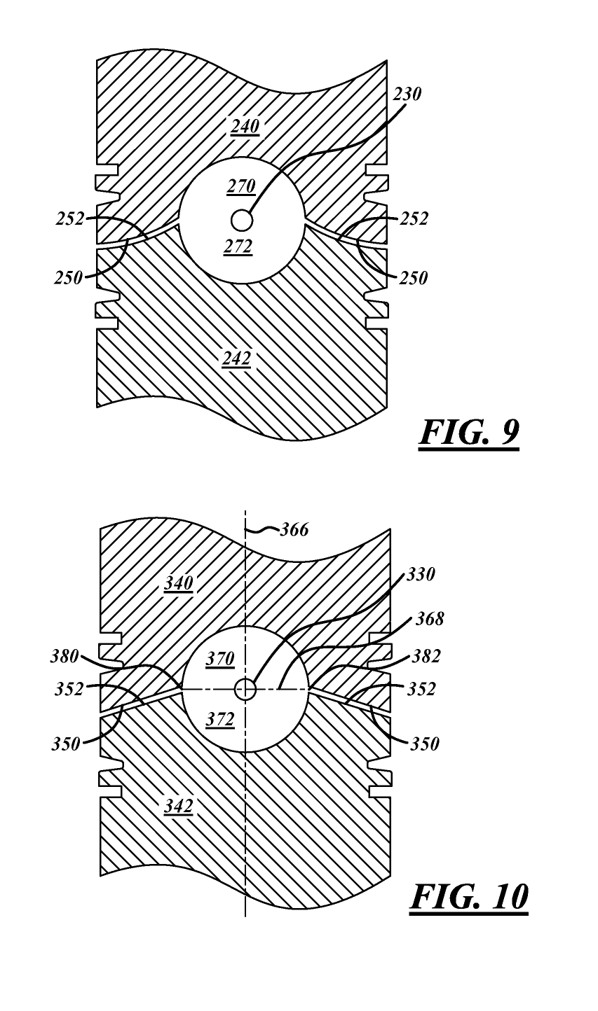

Two alternatives in which the piston tops in the squish regions are not flat are shown in FIGS. 9 and 10. The cross sections in FIGS. 9 and 10 are not through the injector and thus the passageways from the injectors through the periphery of the piston toward the combustion bowl so not intersect this cross section. Instead, a tip of injectors 230 (in FIG. 9) and 330 (in FIG. 10) are visible rather than a side view of the injector, such as injector 60 in FIG. 2.

Referring now to FIG. 9, pistons 240 and 242 form a nearly spherical bowl with piston 240 defining a first portion 270 of the bowl and piston 242 defining a second portion 272 of the bowl. Piston 240 has a convex top 250 in the squish region; and piston 242 has a concave top 252 in the squish region which nests with convex top 250. In FIG. 10, another alternative is shown in which pistons tops 350 and 352 (of pistons 340 and 342, respectively) are flat in cross section. Taken in 3-D, the piston tops in the squish zone are conically shaped. These are two examples of many piston top alternatives in which the piston tops nest when the pistons approach each other such that a small gap is formed between the two pistons and a nearly spherical chamber is formed centrally.

In some alternatives, the central cavity or chamber is not exactly spherical, but is substantially centrally located. Also, in the embodiments illustrated herein, the interface between the squish zone and the combustion chamber bowl is located substantially in a plane perpendicular to a central axis of the cylinder. For example, in FIG. 10, a central axis 366 of the cylinder (not shown) is perpendicular with a plane 368 which includes interfaces 380 and 382 (interfaces between squish zones and the combustion bowl). All the interfaces, i.e., those at other cross sections of the piston not shown here substantially lie in plane 368. Another feature shown in the embodiments herein is that first and second portions, e.g., 370 and 372 in FIG. 10 each contain nearly the same volume.

The combustion chamber bowls in FIGS. 9 and 10 are essentially made up of two hemispheres (270 and 272 in FIGS. 9 and 370 and 372 in FIG. 10) that substantially form a sphere. In the embodiment in FIG. 3 the combustion chamber bowl is made up of two truncated spheres. Either shape may be applied to the various embodiments with the choice depending on the compression ratio, intake flow geometry, and other factors affecting scavenging and combustion.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A combustion chamber for an internal combustion engine, comprising:
a cylinder wall;
a first fuel injector disposed in a first opening defined in the cylinder wall;
a first piston disposed within the cylinder wall with a top of the first piston having:
a squish area covering a majority of the surface area of the top of the first piston and being located substantially near the periphery of the top of the first piston;
a centrally-located concave depression defined in the top of the first piston with a center of the depression being roughly aligned with a central axis of the cylinder wall; and
a first channel defined in the piston top of the first piston connecting an outer edge of the first piston with the depression.

2. The combustion chamber of claim 1 wherein the piston is configured to reciprocate between an upper and a lower position and the first channel provides a line-of-sight opening between a tip of the first injector and the depression when the first piston is at its upper position.

3. The combustion chamber of claim 1 wherein the concave depression is a truncated sphere with a diameter of the truncated sphere less than a diameter of the first piston.

4. The combustion chamber of claim 1 wherein the concave depression is wedge shaped; with the depth of the depression increasing with distance away from the first injector between the channel and a central axis of the first piston.

5. The combustion chamber of claim 4 wherein at the edge of the depression distal from the first fuel injector, the depth of the depression decreases with distance away from the first injector markedly to form a wall that directs fuel injected from the first fuel injector out of the depression.

6. The combustion chamber of claim 1, further comprising:
a second channel defined in the piston top connecting an outer edge of the first piston with the depression; and
a second fuel injector disposed in a second opening defined in the cylinder wall wherein the second fuel injector is substantially diametrically opposed to the first fuel injector.

7. The combustion chamber of claim 6, further comprising:
a first injection orifice defined in the first injector;
a second injection orifice defined in the second injector wherein a spray exiting from the first injector aligns with the first channel when the piston is near its upper position and a spray exiting from the second injector aligns with the second channel when the piston is near its upper position.

8. The combustion chamber of claim 7 wherein the spray from the first injector angles slightly upward and the spray from the second injector angles slightly downward.

9. The combustion chamber of claim 8 wherein the sprays from the first and second injectors are angled so that the sprays remain substantially independent of each other.

10. The combustion chamber of claim 1 wherein the piston is a first piston, the combustion chamber further comprises:
a second piston disposed in the cylinder wall in an opposed arrangement with respect to the first piston with tops of the pistons facing each other wherein the second piston has:
a generally flat top;
a centrally-located concave depression defined in the top of the second piston with a center of the depression being substantially aligned with a central axis of the cylinder wall; and
a first channel defined in the piston top of the second piston wherein the second piston is configured to reciprocate between an upper and a lower position and the first channel in the second piston provides a line-of-sight opening between a tip of the first injector and the depression when the second piston is at its upper position.

11. The combustion chamber of claim 10 wherein the combustion chamber is comprised of a volume enclosed by the tops of the first and second pistons and the cylinder wall.

12. The combustion chamber of claim 1 wherein the diameter of the depression in the piston top is roughly half of the diameter of the piston.

13. An internal combustion engine, comprising:
a cylinder wall;
a first piston disposed in the cylinder liner;
a second piston disposed in the cylinder liner in an opposed arrangement with respect to the first piston;
a crankshaft having eccentric journals;
connecting rods coupling the pistons with eccentric journals of the crankshaft wherein the pistons have an upper position in which a volume in the combustion chamber is at a minimum; and
a first fuel injector disposed in a first opening defined in the cylinder wall,
wherein the first piston has a first channel defined in the first piston top with the first channel providing a line-of-sight opening between a tip of the first injector and the depression in the first piston when the first piston is at its upper position and each piston has:
a flat area covering a majority of the surface area of a top of the piston with the flat area substantially being located peripherally on the top of the piston; and
a concave depression with generally-rounded surfaces defined in the top of the piston.

14. The engine of claim 13, further comprising:
a second fuel injector disposed in a second opening defined in the cylinder wall, wherein the second piston has a second channel defined in the second piston top with the second channel providing a line-of-sight opening between a tip of the second injector and the depression in the second piston when the second piston is at its upper position.

15. The combustion chamber of claim 13 wherein the concave depression in each piston is substantially a truncated sphere with the deepest point of the depression substantially coincident with a central axis of the cylinder.

16. The combustion chamber of claim 13 wherein the concave depression is wedge shaped in which a depth of the depression near the injector is less than the depth of the depression near a central axis of the cylinder.

17. The combustion chamber of claim 14 wherein an orifice of the first fuel injector is oriented to direct a fuel jet into the depression in the first piston and an orifice of the second injector is oriented to direct a fuel jet into the depression in the second piston.

18. The combustion chamber of claim 14 wherein a plurality of orifices defined in the first fuel injector are oriented to direct fuel jets into the depression in the first piston and a plurality of orifices defined in the second injector are oriented to direct fuel jets into the depression in the second piston.

19. The combustion chamber of claim 14 wherein orifices of the first and second fuel injectors are oriented so that a fuel jet exiting the first injector is substantially directed to one side of a plane between tips of the first and second injectors that aligns with a central axis of the cylinder and a fuel jet exiting the second injector is substantially directed to the other side of the plane.

20. An internal combustion engine, comprising:
a cylinder wall;
a first piston disposed in the cylinder liner;
a second piston disposed in the cylinder liner in an opposed arrangement with respect to the first piston;
at least one crankshaft having eccentric journals;
connecting rods coupling the pistons with eccentric journals of the at least one crankshaft wherein the pistons have an upper position in which a volume in the combustion chamber is at a minimum; and
a first fuel injector disposed in the cylinder wall with an axis of the fuel injector roughly normal to the cylinder wall proximate a location where the first fuel injector pierces the cylinder wall,
wherein
each piston has a flat area covering a majority of the surface area of a top of the piston with the flat area being located peripherally on the top of the piston;
each piston has a roughly centrally-located depression defined in the piston top; and
the first piston has a first channel defined in the piston top with the first channel providing a line-of-sight opening between a tip of the first injector and the depression when the first piston is at its upper position.

21. The engine of claim 20, further comprising:
a second fuel injector disposed in the cylinder wall with an axis of the second fuel injector roughly normal to the cylinder wall proximate a location where the second fuel injector pierces the cylinder wall, wherein the second piston further includes a second channel defined in the piston top of the second piston with the second channel providing a line-of-sight opening between a tip of the second injector and the truncated when the second piston is at its upper position.

22. The engine of claim 20 wherein the depression is a truncated sphere.

23. The engine of claim 20 wherein the depression is fan shaped as viewed onto the top of the piston and is wedge shaped as viewed in cross section where the depth of the depression increases as viewed from near the injector to a central axis of the cylinder.
